(19) United States
(12) Patent Application Publication
(10) Pub. No.: US 2011/0255923 A1
(43) Pub. Date: Oct. 20, 2011

(54) METHOD FOR STIMULATING BIODEGRADATION AND THE DEGASSING OF WASTE DISPOSAL SITES

(76) Inventors: Jacobus Cornelis Wammes, Velddriel (NL); Johannes Kasper Van Eijk, Kortenhoef (NL)

(21) Appl. No.: 13/132,498

(22) PCT Filed: Nov. 30, 2009
(86) PCT No.: PCT/NL2009/000239

§ 371 Date: Jul. 5, 2011

(30) Foreign Application Priority Data
Dec. 3, 2008 (NL) 1036270

(51) Int. Cl. B09B 1/00

(52) U.S. Cl. 405/129.85

(57) ABSTRACT

The present invention relates to a method for stimulating biodegradation and the degassing of waste disposal sites by installing degassing pipes therein. The present invention further relates to a special waste disposal site. It is therefore an object of the present invention to increase the extent of biodegradation as well as the extent of degassing of a waste disposal site.

The present invention relates to a method for stimulating biodegradation and the degassing of waste disposal sites by installing degassing pipes therein. The present invention further relates to a special waste disposal site.

Waste disposal sites are widely known. Such waste disposal sites are often situated on wasteland, on which a sealing layer may be installed before waste is deposited thereon. Such a sealing layer functions to prevent pollution of the soil and the ground water. It is a known fact that in such waste disposal sites the organic waste will decompose into all kinds of gases, mainly consisting of methane and carbon dioxide, as a result of a natural composting process that takes place. The gas thus formed slowly finds its way into the environment, which, in the case of methane gas, can be regarded as harmful to the environment. In practice the gas can be captured by means of a pipe system, for example, which captured gas, after possible refinement thereof, is used for energy recovery. A good and rapid decomposition of the organic material during the operational phase of these capturing systems is important with a view to preventing gases from being released into the atmosphere yet during a subsequent phase or organic materials from being leached out and contaminating the soil and the ground water. Trapped percolate may also be released after the operational phase of the disposal site and contaminate the soil and the ground water.

The present inventor has found that “active” and “non-active” regions exist within such a waste disposal site, in which connection the term “activity” must be regarded in the light of the composting or fermentation behaviour. In the so-called “active” regions, a spontaneous fermentation reaction of organic components occurs, resulting in the formation of methane gas, among other fermentation products. In the “non-active” regions, little if any decomposition of organic components occurs. Although a waste disposal site as such comprises a combination of non-organic waste and organic waste, the absence of a fermentation reaction in certain regions of the waste disposal site is not desirable. Accordingly it is an object of the present invention to increase the extent of biodegradation as well as the extent of degassing of a waste disposal site.

The present invention as described in the opening paragraph is characterised in that the method comprises the following steps:
i) installing prefabricated drainage pipes directly in vertical direction in the waste disposal site,
ii) interconnecting said drainage pipes via a pipe system located above the waste present at the surface of the waste disposal site or directly below the surface of said waste.

The above object can be accomplished by using such a method. It has in particular been found to be possible to have the entire waste disposal site take an active part in the decomposition and the gas production by installing the drainage pipes directly in the waste disposal site, in closely spaced relationship, rather than using a more common method as known from U.S. Pat. No. 4,670,148, according to which shafts are first dug, spaced much further apart, whereupon one or more degassing pipes are installed in the shafts. According to the present invention it is thus possible to install drainage pipes a relatively short distance apart, preferably 1-7 metres, in the waste disposal site, so that the isolated regions in the waste disposal site can be opened up by placing such regions into communication with each other within the waste disposal site. As a result, excess (percolate) water can more easily spread to drier regions in the waste disposal site so as to locally increase the bioactivity in said regions and the gas that has formed can more easily migrate. Trapped water can also migrate to the surface via the drainage pipe when placed under tension as a result of consolidation of the disposal site under its own weight.

Using the present method, it has also been found to be possible to obtain a rapid and efficient settlement or consolidation of the waste disposal site. In addition to that it has been found to be possible, using the present method, to effect the discharge of percolate into the drainage system that is already present in the ground at the waste disposal site. Waste disposal sites often comprise horizontal layers which are not very permeable to water, which layers prevent percolate from draining in downward direction, causing the percolate to be trapped or draining from the waste disposal site on the sides thereof, which is undesirable. By using the present method, according to which drainage pipes are directly installed in vertical direction in the waste disposal site, a more or less free passage for vertical transportation of gas as well as (percolate) water is created by the use of such vertical drainage pipes. The term “in vertical direction” is to be understood to means up to an angle of at least 45° relative to the surface level. This means that the vertical drainage pipes can be installed in an inclined manner. As a result of the shorter distance apart between the pipes, the vertical drainage pipes are also in communication with each other at several locations via horizontal waste layers that are permeable to water and/or gas.

The drainage pipe used in the present method is preferably made up of a prefabricated, flexible section, which section is surrounded by a filter material at the outer circumference thereof. Said filter material is designed so that clogging thereof by soil particles is prevented, whilst the filter material is sufficiently permeable to liquid and gas, so that vertical transportation of liquid and gas via the drainage pipe is possible. The drainage pipe is open at both ends. Polypropylene and polyethylene are suitable materials in this regard.

If the drainage pipes are installed in vertical direction in the waste disposal site, a pipe system may be connected to the drainage pipes present at the surface of the waste disposal site, which pipe system functions to discharge the gases that have formed in the waste disposal site via the drainage pipes. In this case the drainage pipes and/or the discharge pipes of the aforesaid drainage system must blend into a closed pipe system at some distance below the surface of the waste of the waste disposal site, which closed system discharges the gases that have formed in the waste disposal side to the outside. This is necessary in order to prevent the escape of gas to the surface and the ingress of air from the surface. In addition to that it has also been found to be possible to use such pipes and drainage pipes for transporting water or percolate to the waste disposal site itself, for the transportation of which water a certain overpressure may be used. In this way inactive regions of the disposal site that are too dry can be activated. Such an aqueous flow may also contain micro bacteria, which can generate bioactivity in the waste disposal site.

In a special embodiment of the present method, the method is preferably combined with the use of a top seal on the waste disposal site, so that the escape of undesirable gases into the atmosphere and the ingress of oxygen into the gas discharge system from the surface is minimized. Materials suitable for use in top seals include mineral sealing materials, such as clay, clay/sand mixtures and bentonite/polymer mixtures, such as the mixtures according to European patent Nos. 0 682 684; 1 012 214; 1 250 494; 1 265 973 and 1 985 586, whose contents may be considered to be incorporated herein, or plastic materials, such as foil materials. The aforesaid European patents are registered in the name of the present applicant. In this embodiment the pipe system that is used is preferably installed entirely or partially under the top seal, so that the number of passages through the sealing layer itself can be limited to the joined/combined pipes. Moreover, the pipe system under the sealing layer need not be closed, and in addition to being capable of discharging gas from the vertical drainage pipes, the pipe system is also capable of draining the gas that builds up in the layer present under the sealing layer. Instead of using a pipe system under the sealing layer, to which all vertical drainage pipes are individually connected, it is also possible when using this embodiment to replace the pipe system partially or entirely by, for example, a drainage system selected from a layer of a porous material or channels of a porous material, or a drainage mat. In such systems, the gas both from the vertical drainage pipes and from the surface of the waste can collect in porous cavities or channels in the drainage layer. This system can be used in combination with a pipe system which discharges the gas in the drainage layer via closed pipes through the sealing layer or top seal. Substituting closed pipes for draining systems as described above has the advantage that condensation can lead to the formation of water seals, with the pipe not exhibiting a fall (any more), so that the gas cannot flow through the pipe any more. Likewise, percolate water can migrate upwards through the vertical drainage under the influence of the pressure of the weight of the disposal site and block the passage of the gas through the closed pipes. In the porous drainage layer, the gas exiting from the waste disposal site is collected and discharged collectively rather than via the individual drainage pipes.

In a special embodiment of the present method, a mineral sealing layer is provided as the top seal of the waste disposal site, which layer will become sufficiently gas-tight upon being saturated with water. Preferably, a ballast layer is provided on top of said layer, which ballast layer must be sufficiently thick to prevent dehydration of and damage to the sealing layer. Such a mineral sealing layer allows any excess gas pressure to pass but recovers after said passage on account of its self-recovery capacity and its weight. As a result of the provision of a large number of drainage pipes, a large amount of gas may spontaneously come to the surface at a several locations. A mineral layer which is relatively dry upon being provided will first transmit gas but form a seal once it becomes saturated with water. An example of a mineral material which is relatively dry upon being provided but which is quite capable of retaining water is a material as disclosed in one of the aforesaid patents in the name of the present applicant. Using welding of foils as a sealing layer, which is often done in practice, is dangerous in the presence of landfill gases which collect under the foil and which may explode. An excessive gas pressure may lift and cause damage to the entire foil structure.

In a special embodiment of the present method, a bioactive top layer is provided as the top seal of the waste disposal site, in which layer the microorganisms convert the harmful methane gases and odour components being emitted into CO2 and water as a result of the availability of oxygen. To achieve an effective reduction of methane emissions, it must be ensured that the methane finds its way into the top layer in a balanced manner. If a sealing layer is not used for reducing the methane emissions and spreading them over the surface, it is desirable to use a distribution layer. Said distribution layer distributes the methane being supplied from the waste package of the waste disposal site to the top layer.

To install the present, already prefabricated drainage pipes directly in vertical direction in the waste disposal site, it is desirable that step i) be carried out by using a hollow guide lance, which lance, with the drainage pipe present therein, is pressed vertically downwards into the waste disposal site. When the lance is pressed into the waste disposal site, the bottom side of the lance is provided with a plate to which the drainage pipe is attached, which plate displaces the waste material in the waste disposal site and which will remain behind at the installation depth in the waste disposal site when the lance is removed from the waste disposal site for subsequently installing a new drainage pipe at another location at the waste disposal site.

To achieve an efficient extraction of gas from the waste disposal site it is desirable that the pipe system be configured so that an underpressure can be generated in drainage pipes installed in the waste disposal site and/or the pipe system present under the seal.

The present invention thus relates to the use of drainage pipes installed in vertical direction in waste disposal sites for degassing the waste disposal site. The present invention further relates to the use of drainage pipes installed in vertical direction in waste disposal sites for aiding in the settlement of the waste disposal site.

The present invention in particular relates to the activation of the entire waste disposal site for the purpose of thus taking part in the active decomposition and gas production, wherein the previously non-active parts are opened up to water and gas. According to the method of the present invention it is also possible to supply water to the drainage pipes, so that a discharge of soluble and/or mobile non-degradable harmful substances to the percolate drain at the bottom of the waste disposal site can take place in the waste disposal site, so that a less harmful waste disposal site will remain. The percolate thus obtained can be pumped out and be subjected to a purification treatment. Using the present method it has thus been found to be possible to increase the overall gas yield of a waste disposal site, thus realising not only a more rapid gas yield but also a more complete biodegradation of the waste disposal site itself.

1. A method for stimulating biodegradation and the degassing of waste disposal sites by installing degassing pipes therein, wherein the method comprises the following steps:
installing prefabricated drainage pipes directly in vertical direction in a waste disposal site, by pressing the prefabricated drainage pipe in vertically downward direction into the waste disposal site in a hollow guide lance, the bottom side of said lance being provided with a plate to which the drainage pipe is attached, which plate displaces the waste material in the waste disposal site and which will remain behind in the waste disposal site when the lance is removed from the waste disposal site at the depth at which the drainage pipe is installed in the bottom of the waste disposal site, and
installing a drainage layer on the waste present at the surface of the waste disposal site, and
installing a top seal for gas and water on top of said drainage layer, wherein the gas both from the vertical drainage pipes and from the surface of the waste can collect in porous cavities or channels in the drainage layer, and
installing a pipe system which discharges the gas in the drainage layer via closed pipes through said top seal to the outside.

2. The method according to claim 1, wherein the drainage pipe comprises a prefabricated, flexible plastic section, which section is surrounded by a filter material at the outer circumference thereof.

3. The method according to claim 2, wherein the filter material comprises thermally bound polypropylene fibres.

4. The method according to claim 1 wherein the drainage pipes are installed at a vertical level of less than 4 meters from the bottom seal of a waste disposal site and any drainage system present therein.

5. The method according to claim 1 wherein the drainage pipes are installed in the waste disposal site at a depth such that the drainage pipes form a connection with a drainage system that is already present in the waste disposal site.

6. The method according to claim 1 wherein the drainage pipes are interconnected via a pipe system located above waste present at the surface of the waste disposal site or directly below the surface of said waste.

7. The method according to claim 6, a top seal comprises a layer of mineral sealing material.

8. The method according to claim 6, wherein the drainage layer is selected from a layer of a porous material, a drainage mat and a drainage channel of a porous material.

9. The method according to claim 6 wherein said pipe system is partially or entirely located under the top seal of the waste disposal site.

10. The method according to claim 6 wherein the drainage layer under the top seal is partially or entirely substituted for a pipe system wherein said drainage pipes are interconnected.

11. (canceled)

12. The method according to claim 1 wherein the vertical drainage pipes are installed in the waste disposal site at a distance of 1-7 meters from each other.

13. The method according to claim 1 wherein drainage layer and/or the pipe system is so configured that an underpressure can be generated in the drainage layer and/or said drainage pipes installed in the waste disposal site.

14. The method according to claim 1 wherein the drainage layer and/or pipe system is so configured that water can be supplied to the drainage pipes.

15. The method according to claim 1 wherein as said top seal a bioactive top layer is provided at the surface of the waste disposal site, in which microorganisms present therein convert methane gases and odor components being emitted from the waste disposal site into CO₂ and water as a result of the availability of oxygen.

16. The method according to claim 1 wherein the drainage pipes are installed in the waste disposal site at an angle of at least 45° relative to the surface level.

17. A waste disposal site provided with regularly spaced-apart, drainage pipes installed in vertical direction wherein on waste present at a surface of the waste disposal site is present a drainage layer, wherein on top of said drainage layer a top seal for gas and water is present, wherein the gas both from the vertical drainage pipes and from the surface of the waste can collect in porous cavities or channels in the drainage layer, and a pipe system which discharges the gas in the drainage layer via closed pipes through the top seal to the outside.

18. The waste disposal site according to claim 17, wherein a top seal comprises a layer of mineral sealing material.

19. The waste disposal site according to claim 17 wherein the drainage layer is selected from a layer of a porous material, a drainage mat and a drainage channel of a porous material, in which drainage layer drainage pipes installed in vertical direction terminate.

20. The waste disposal site according to claim 17 wherein the vertical drainage pipes are spaced 1-7 meters apart in the waste disposal site.

21. (canceled)

22. (canceled)

23. (canceled)

24. The waste disposal site according to claim 17, wherein said top seal comprises a bioactive top layer in which layer microorganisms convert methane gases and odor components being emitted.
